(19) United States
(12) Patent Application Publication
(10) Pub. No.: US 2009/0076979 A1
(43) Pub. Date: Mar. 19, 2009

(54) DETERMINING INVESTOR INTEREST

(76) Inventor: Barry E. Silbert, New York, NY (US)

Correspondence Address: HOLLAND & KNIGHT LLP, 10 ST. JAMES AVENUE, 11th Floor, BOSTON, MA, 02116-3889, US

(21) Appl. No.: 12/104,144

(22) Filed: Apr. 16, 2008

Related U.S. Application Data
(60) Provisional application No. 60/946,835, filed on Jun. 28, 2007.

(51) Int. Cl. G06Q 40/00

(52) U.S. Cl. 705/36 R; 705/37

(57) ABSTRACT

A method and computer program product for defining one or more investor portfolio preferences for a user. The one or more investor portfolio preferences are compared to one or more attributes of a security. An interest score for the user relative to the security is generated.

### CROSS-REFERENCE TO RELATED APPLICATIONS

This application claims priority to provisional application serial no. 60/946,835, filed Jun. 28, 2007, entitled “SYSTEM AND METHOD FOR TRADING RESTRICTED SECURITIES,” the entire contents of which are incorporated herein.

### FIELD OF THE DISCLOSURE

The present disclosure relates to identifying investor interest in securities, and more particularly relates to identifying investor interest in securities based upon security attributes and weighted investor portfolio preferences.

### BACKGROUND

A wide variety of securities are publicly and privately traded on numerous exchanges, private transactions, and the like. Similarly, a great deal of research is conducted relative to various securities, industries, markets, and the like, allowing for informed securities portfolio development and management. However, the great diversity in securities and information gives rise to the problem of matching available securities with interested investors. Even broad matches, e.g., based on the type of security, industry or sector of the issuer of the security, and the like, between available securities and individual investors does little to simplify the problem as great sub-classes and combinations of the security types, industries, offering sizes, etc. exist. As such, many investors are never notified of securities offerings for which the investor has an interest. Similarly, investors are constantly flooded with information about securities offering for which they have no interest. The result of this situation is often missed opportunities for investors and fewer than possible sales by securities traders. It would, therefore, be desirable to provide a mechanism for more accurately determining the probability that a given investor will be interested in a particular securities offering.

### SUMMARY OF DISCLOSURE

According to a first implementation, a method includes defining one or more investor portfolio preferences for a user. The one or more investor portfolio preferences are compared to one or more attributes of a security. An interest score for the user relative to the security is generated.

One or more of the following features may be included. The one or more investor portfolio preferences for the user may include one or more of: security type, security position size, security industry, security issuer market capitalization, and listed security ask price. Defining the one or more investor portfolio preferences for the user may include defining one or more investor portfolio preferences based upon, at least in part, an investor survey. The one or more attributes of the security may include one or more of: security type, security position size, security industry, security issuer market capitalization, and listed security ask price. The security may include a restricted security.

Comparing the one or more investor portfolio preferences to the one or more attributes of the security may include associating a weighting factor to one or more of the one or more investor portfolio preferences. The weighting factor may be based upon, at least in part, one or more of: one or more stated investor portfolio preferences for the user, one or more historical transactions of the user, one or more historical bids of the user, one or more declared interests of the user, one or more listed positions monitored by the user, current portfolio holdings of the user, one or more user affirmed positions of interest, an indicated securities exchange preference of the user, and indicated special purchase interest of the user, a qualified institutional buyer status of the user, amount of assets under management by the user, and a relative time spent by the user viewing one or more securities positions. The interest score for the user may be indicative of a probability of the user bidding the security.

According to another implementation, a computer program product resides on a computer readable medium having a plurality of instructions stored on it. When executed by a processor, the instructions cause the processor to perform operations including defining one or more investor portfolio preferences for a user. The one or more investor portfolio preferences are compared to one or more attributes of a security. An interest score for the user relative to the security is generated.

One or more of the following features may be included. The one or more investor portfolio preferences for the user may include one or more of: security type, security position size, security industry, security issuer market capitalization, and listed security ask price. The instructions for defining the one or more investor portfolio preferences for the user may include instructions for defining one or more investor portfolio preferences based upon, at least in part, an investor survey. The one or more attributes of the security may include one or more of: security type, security position size, security industry, security issuer market capitalization, and listed security ask price. The security may include a restricted security.

The instructions for comparing the one or more investor portfolio preferences to the one or more attributes of the security may include instructions for associating a weighting factor to one or more of the one or more investor portfolio preferences. The weighting factor may be based upon, at least in part, one or more of: one or more stated investor portfolio preferences for the user, one or more historical transactions of the user, one or more historical bids of the user, one or more declared interests of the user, one or more listed positions monitored by the user, current portfolio holdings of the user, one or more user affirmed positions of interest, an indicated securities exchange preference of the user, an indicated special purchase interest of the user, a qualified institutional buyer status of the user, amount of assets under management by the user, and a relative time spent by the user viewing one or more securities positions. The interest score for the user may be indicative of a probability of the user bidding the security.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts an investor interest process coupled to a distributed computing network.

FIG. 2 is a flow chart of a process that may be executed by the investor interest process of FIG. 1.

### DETAILED DESCRIPTION OF PREFERRED EMBODIMENTS

### SYSTEM OVERVIEW

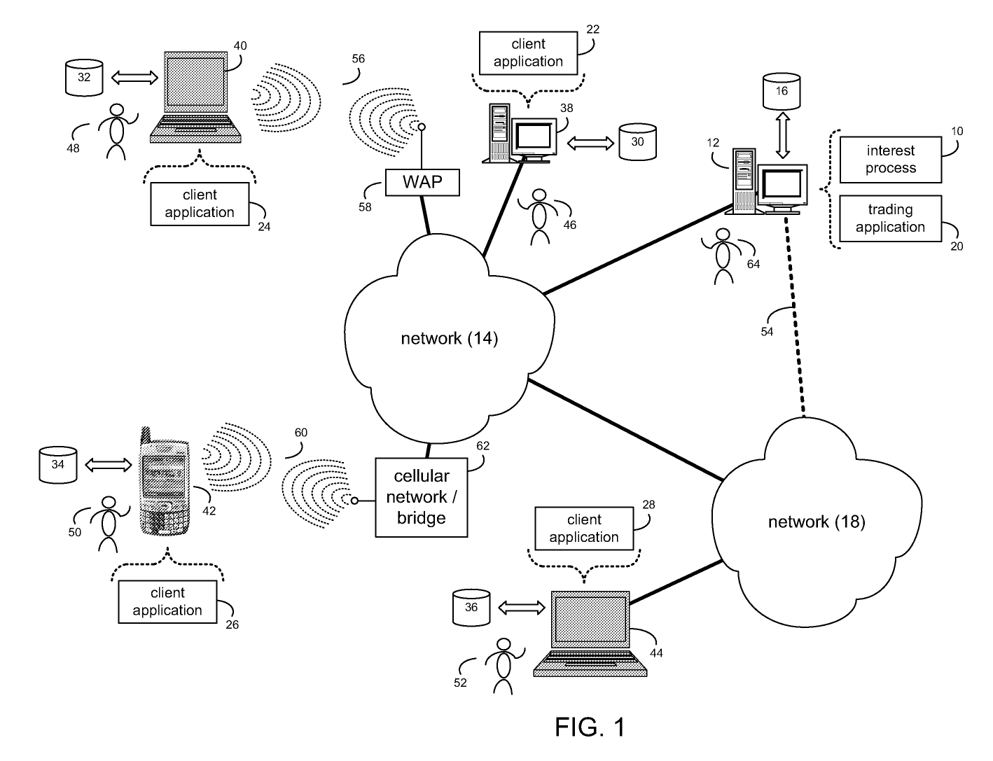

Referring to FIG. 1, there is shown investor interest process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, the investor interest process may reside on a client electronic device, such as a personal computer, notebook computer, personal digital assistant, or the like.

As will be discussed below in greater detail, investor interest process 10 may define one or more investor portfolio preferences for a user. The one or more investor portfolio preferences may be compared to one or more attributes of a security. An interest score for the user relative to the security may be generated.

The instruction sets and subroutines of investor interest process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more securities trading applications (e.g., trading application 20), examples of which may include but are not limited to, e.g., a restricted securities trading platform, such as the RSTN® trading platform provided by Restricted Stock Partners. Trading application 20 may interact with one or more client applications (e.g., client applications 22, 24, 26, 28) allowing, for example, securities offerings to be viewed, specific securities positions to be monitored, inquiries regarding securities positions to be made, and securities transactions (e.g., bid on and/or purchase securities, and the like) to be conducted, etc. Examples of client applications 22, 24, 26, 28 may include, but are not limited to, e.g., a web browser (e.g., Microsoft Internet Explorer™), or a proprietary interface application. Investor interest process 10 may be a stand-alone application, a stand-alone application that interfaces with trading application 20, or may be an applet/application that is executed within trading application 20.

The instruction sets and subroutines of trading application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, the investor interest process may be a client-side application (not shown) residing on one or more client electronic devices 38, 40, 42, 44 (e.g., stored on storage devices 30, 32, 34, 36, respectively). As such, the investor interest process may be a stand-alone application that interfaces with a client application (e.g., client applications 22, 24, 26, 28), or may be an applet/application that is executed within a client application. As such, the investor interest process may be a client-side process, a server-side process, or a hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may, for example, view securities offerings, monitor specific securities positions, and/or conduct securities transactions. Viewing securities offerings, monitoring securities positions or offerings, and conducting securities transactions may include accessing and/or interacting with trading application 20.

Users 46, 48, 50, 52 may access trading application 20 directly through the device on which the client application (e.g., client applications 22, 24, 26, 28) is executed, namely client electronic devices 38, 40, 42, 44, for example. Users 46, 48, 50, 52 may access trading application 20 directly through network 14 or through secondary network 18. Further, server computer 12 (i.e., the computer that executes trading application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### INVESTOR INTEREST PROCESS

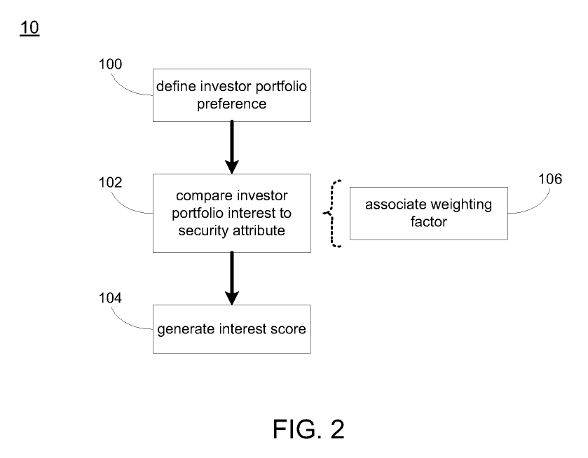

Referring also to FIG. 2, investor interest process 10 may define 100 one or more investor portfolio preferences for a user. The one or more investor portfolio preferences may be compared 102 to one or more attributes of a security. An interest score for the user relative to the security may be generated 104.

The one or more investor portfolio preferences for the user may include one or more of: security type, security position size, security industry, security issuer market capitalization, and listed security ask price. That is, for example, the one or more investor portfolio preferences may be indicative of the nature of securities that an investor may wish to incorporate into an investment portfolio.

The security type may include stocks, such as common stock and preferred stock, for example (e.g., including restricted and/or unregistered stock). Common stock may generally include a unit of ownership in a company. Common stock may typically carry voting rights that can be exercised in corporate decision making. Similarly, preferred stock may also include a unit of ownership in a company. However, preferred stock typically may not carry voting rights, but rather may carry an entitlement to receive a level of dividend payments before dividends can be issued to other shareholders. Of course, various other rights and/or privileges may be associated with one or more of common stock and preferred stock.

Warrants may generally include options issued by a company that allow the holder of the warrant to purchase a specific number of shares at a specified price within a specified time. Often, warrants may be issued together with bonds or other existing equities. Further, warrants may be detachable from the bonds or other existing equities, and may be separately tradable.

Debt securities may include, for example, debentures, bonds, trade claims, deposits, notes or commercial paper depending on their maturity and certain other characteristics. Debt securities may entitle the holder to the payment of principal and interest, together with other contractual rights under the terms of the issue, such as the right to receive certain information. Debt securities may generally be issued for a fixed term and may be redeemable by the issuer at the end of that term.

Convertibles may generally include bonds or preferred stock, which can be converted, at the election of the holder of the convertibles, into common stock of the issuing company. Security type may also include various additional and/or alternative types of securities, such as, but not limited to, primary offerings (e.g., Private Investments in Public Entities and Initial Public Offerings), options (e.g., employee stock options), and various illiquid assets (e.g., life insurance settlements), for example.

Security position size may generally refer to a given amount of securities. The position size may be, for example, defined in terms of the value of the position. The position size of the investor portfolio preferences of the user may be indicated by bracket value. For example, the position size may include, but is not limited to, brackets of between $0-$100,000, $100,000-$250,000, $250,000-$500,000, $500,000-$1 million, $1 million-$5 million, $5 million-$10 million, and greater than $10 million. The foregoing brackets are intended merely as illustrated, and not intended as a limitation of this disclosure, as various other brackets and/or designators of position size may equally be utilized. The security position size may generally indicate the size of any given position that the user may be interested in acquiring.

Security industry may generally refer to an industry and/or sector in which the issuer of the security operates. Security industry may be broken into any variety of broad classes of industries and/or sectors. For example, the industry classes may include, but are not limited to: automobiles and components; food, beverages and tobacco; real estate; banks; health care equipment and services; retailing; basic materials; hotels; restaurants and leisure; software and services; capital goods; household and personal products; technology hardware and equipment; commercial services and supplies; insurance; telecommunication services; consumer durables and apparel; media; transportation; diversified financial; pharmaceuticals and biotechnology; and utilities. Of course, the foregoing industry classes are set forth merely for illustrative purposes and are not intended to be a limitation of the present disclosure, as any other varieties of industry classes may be equally utilized.

Security issuer market capitalization may generally provide a measurement of corporate or economic size of the issuer of the security. Market capitalization may generally be equal to the share price times the number of shares outstanding of a public company. Similar to security position size, security issuer market capitalization may be indicated by bracket values. For example, security issuer market capitalization may include, but is not limited to, brackets of: less than $50 million, $50 million-$250 million, $250 million-$1 billion, $1 billion-$5 billion, and greater than $5 billion. However, it should be understood that the foregoing brackets are intended only for illustrative purposes and should not be construed as a limitation of this disclosure, as other brackets and/or designators of market capitalization may be equally utilized.

Investor portfolio preferences may include listed security ask price. The listed security ask price may include a per share price of a security. However, it will be appreciated that not all security listings may have a per share price.

Further, in the context of restricted securities (e.g., securities such as unregistered, control, and affiliate stock and warrants, which may not be fully transferable until certain conditions have been met), investor portfolio preferences may also include the time left on the restriction. That is, the investor portfolio preferences for restricted securities may include the amount of time until the security may be publicly saleable (and therefore, sellers of which may be able to avail themselves of traditional public markets). As with position size and market capitalization, the time left on the restriction may be bracketed. For example, time left on the restriction brackets may include, but is not limited to, one month, three months, six months, nine months and 12 months. Of course, these time brackets are set forth for the purpose of illustration, and are not intended as a limitation of this disclosure, as other time brackets may be equally utilized.

Defining the one or more investor portfolio preferences for the user may include defining one or more investor portfolio preferences based upon, at least in part, an investor survey. For example a user (i.e., an investor) may initially complete a survey that may be directed at ascertaining the types of securities, industry or sector of the issuer, and the like that a user may wish to acquire as part of an investment portfolio. The survey may request indicators of preferences directed at the above-discussed investor portfolio preferences as well as various additional information directed at ascertaining investment interests of the user.

The one or more attributes of the security may include one or more of: security type, security position size, security industry, security issuer market capitalization, and listed security ask price. The one or more attributes of the security may correspond to one or more of the investor portfolio preferences. As such, a match between one or more of the investor portfolio preferences to one or more attributes of a security may indicate a greater probability of interest in the security by the user. As mentioned above, the security may include a restricted security.

Investor interest process 10 may compare 102 the one or more investor portfolio preferences to one or more attributes of the security. Comparing 102 the one or more investor portfolio preferences to the one or more attributes of the security may include associating 106 a weighting factor to one or more of the one or more investor portfolio preferences. The weighting factor associated 106 with one or more of the investor preferences may, for example, emphasize various investor portfolio preferences based upon, at least in part, a perceived importance to the user. Various weighting schemes may be utilized for associating 106 the weighting factor with one or more of the investor portfolio preferences.

The weighting factor may be based upon, at least in part, one or more of: one or more stated investor portfolio preferences for the user, one or more historical transactions of the user, one or more historical bids of the user, one or more declared interests of the user, one or more listed positions monitored by the user, current portfolio holdings of the user, one or more user affirmed positions of interest, an indicated securities exchange preference of the user, and indicated special purchase interest of the user, a qualified institutional buyer status of the user, one or more assets under management by the user, and a relative time spent by the user viewing one or more securities positions.

The weighting factor associated 106 with one or more of the one or more investor portfolio preferences may be based upon, at least in part, one or more stated investor portfolio preferences for the user. For example, as mentioned above, the user may complete a survey relative to various preferences, e.g., which may correlate to one or more security attributes. Via the survey, the user may state one or more given preferences relative to one or more security attributes. For example, the user may state a preference for common stock in high market capitalization (e.g., greater than $1 billion market capitalization, for example) semiconductor companies. As such, a higher weighting may be given to common stock, high market capitalization companies, and companies in the technology hardware and equipment industry in comparing 102 investor portfolio preferences of the user to security attributes. Of course, greater or lesser granularity may be utilized in associating 106 weighting parameters.

Continuing with the above-stated example, the weighting factor associated 106 with one or more of the one or more investor portfolio preferences may be based upon, at least in part, one or more historical transactions of the user. For example, while the user may have stated a preference for common stock in high market capitalization semiconductor companies, the majority of securities transactions previously undertaken by the user may have involved preferred stock in low market capitalization (e.g., below $250 million market capitalization, for example) pharmaceutical companies. Therefore, notwithstanding a stated preference for common stock in high market capitalization technology hardware and equipment companies, investor interest process 10 may associate 106 a relatively high weighting factor with preferred stock, low market capitalization, and pharmaceutical companies (either with respect to the individual attributes of security type, market capitalization, and industry, or as an aggregate to preferred stock in low market capitalization pharmaceutical companies), consistent with a preference perceived from the user's historical transactions.

While transaction history may indicate those securities that have actually been purchased by the user, investor interest process 10 may also associate 106 a weighting factor based upon, at least in part, one or more historical bids of the user, e.g., which may be indicative of interests of the user that have not been realized in terms of securities actually purchased by the user. Continuing with the above-stated example, while the user's transaction history may indicate a preference for preferred stock in low market capitalization pharmaceutical companies, the user may frequently, albeit unsuccessfully, bid on debt securities for media companies in which there is between six months and nine months left on the restriction. Despite the user's lack of success in acquiring the debt securities for media companies with between six and nine months left on the restriction, investor interest process 10 may associate 106 a weighting factor (e.g., with debt securities for media companies with between six and nine months left on the restriction and/or individually with debt securities, and remaining restriction time of between six and nine months individually) indicative of the user's interest expressed by the user's bidding history.

The user may have one or more declared interests, e.g., in specific securities types, position size, industries, and the like, which may be initially indicated in the investor survey, which may be subsequently affirmed, for example, based upon, at least in part, transaction of the user, positions monitored by the user, and the like. Investor interest process 10 may associate 106 a weighting factor based upon, at least in part, the one or more declared interests of the user, indicating a higher interest of the user in such securities, industries, position sizes, etc.

As previously described, trading application 20 may, in part, allow a user (e.g., user 46) to monitor securities positions or offerings. For example, trading application 20 may allow user 46 to indicate one or more securities positions (e.g., a $300,000 block of common stock in a particular telecommunications company) to be monitored. Trading application 20 may provide, e.g., in a user interface screen (not shown), continuous and/or intermittent information (e.g., most recent bid prices, number of bids placed, security type, etc.) regarding the indicated one or more securities positions being monitored. Investor interest process 10 may associate 106 a weighting factor with common stock positions in the $250,000-$500,000 range for telecommunications companies and/or individually with common stock securities, positions sized in the $250,000-$500,000 range and telecommunications services, based upon, at least in part, the user's interest in monitoring the particular position.

Similarly, the weighting parameter associated 106 with one or more of the one or more investor portfolio preferences may be based upon, at least in part, a relative time spent by the user viewing one or more securities positions. While the user may not indicate a particular security position to be monitored by trading application 20, the user may nonetheless frequently view one or more securities positions, e.g., via trading application 20. For example, via trading application 20 user 46 may daily view the status (e.g., current bid price, or the like) of offerings of debt securities for software companies having a market capitalization of between $150 million and $200 million. Investor interest process 10 may associate 106 a weighting parameter with debt securities for software companies having market capitalization between $50 million and $200 million and/or individually with debt securities, software companies, and companies having market capitalization between $50 million and $200 million based upon, at least in part, the time spent by user 46 viewing such positions, e.g., as compared to time spend viewing other positions.

In addition to perceived interests, the user may affirmatively express an interest (e.g., to a trader via in person, telephone, instant messaging communications, or the like) in one or more positions. The trader may indicate the interest expressed by the user, e.g., via an entry into a data store, such as a database, accessible by investor interest process 10. Investor interest process 10 may associate 106 a weighting factor with one or more investor portfolio preferences correlated to the user's expressed interest.

Investor interest process 10 may associate 106 a weighting parameter based upon, at least in part, an indicated securities exchange preference of the user. For example, the user may specify (e.g., on an investor survey) one or more preferred securities exchanges (e.g., NYSE, NASDAQ, AMEX, Bulletin Board, Pink Sheets, foreign exchanges). Similarly, the user may specify a preference against one or more securities exchanges. In comparing 102 the one or more investor portfolio preferences to the one or more attributes of a security, investor interest process 10 may associate a weighting parameter that may reflect the user's specified securities exchange preference.

The user may indicate an interest in one or more special purchases. For example, the user may indicate (e.g., on the investor survey) an interest in distressed securities, hedge funds, minority stakes, PIPEs (private investment in public equity), portfolio securities, and/or private company securities. Investor interest process 10 may associate 106 a weighting parameter with one or more investor portfolio preferences based upon, at least in part, the user's indicated special purchase, thereby reflecting an interest of the user in such securities.

The weighting parameter associated 106 with the one or more investor portfolio preferences may be based upon, at least in part, a qualified institutional buyer status of the user, e.g., which may be indicated on an investor survey, etc. For example, for a qualified institutional buyer, investor interest process 10 may associate 106 a weighting parameter indicating a greater likelihood of an interest in higher position size offerings, securities issued by larger market capitalization companies, higher per-share ask prices, etc.

Investor interest process 10 may associate 106 a weighting parameter based upon, at least in part, current portfolio holdings of the user. For example, if the user's current portfolio includes a large number of common and preferred stocks for energy companies having a market capitalization greater than $1 billion, investor interest process 10 may associate a weighting parameter reflecting the user's interest in common and preferred stock for energy companies having a market capitalization of between $1 billion and $5 billion, and/or individually for common and preferred stock, energy companies, and companies having a market capitalization of between $1 billion and $5 billion.

Similarly, investor interest process 10 may associate 106 a weighting parameter based upon, at least in part, the amount of assets under management by the user. For example, if the user manages assets in excess of $100 million, investor interest process 10 may associate 106 a weighting parameter indicating, for example, a greater possible interest in larger positions, higher market capitalization, and the like.

One or more of the weighting parameters associated 106 with one or more of the one or more investor portfolio preferences may include a temporal component. For example, a year ago the user may have acquired (e.g., engaged in a transaction) preferred stock in a low market capitalization (e.g., below $250 million market capitalization, for example) pharmaceutical company. As such, investor interest process 10 may associate 106 a weighting factor with preferred stock, low market capitalization, and pharmaceutical companies (either with respect to the individual attributes of security type, market capitalization, and industry, or as an aggregate to preferred stock in low market capitalization pharmaceutical companies), consistent with a preference perceived from the user's historical transaction. However, since the acquisition of the preferred stock in the low market capitalization pharmaceutical company, the user may have conducted several transactions involving common stock in high market capitalization (e.g., greater than $1 billion market capitalization) pharmaceutical companies. Accordingly, while historical transactions may indicate an interest in preferred stock in low market capitalization pharmaceutical companies, the length of time since such transactions and/or the intervening transactions involving common stock in high market capitalization pharmaceutical companies may diminish the weighting parameter associated 106 with preferred stock in low market capitalization pharmaceutical companies, and/or individually with preferred stock and low market capitalization.

Similar to the preceding example, investor interest process 10 may include a temporal component in the weighting parameters associated 106 with one or more of the other investor portfolio preferences, including, but not limited to, historical transactions, historical bids, monitored securities positions, time spent viewing securities positions, expressed interests, and the like. Accordingly, the weighting parameter associated 106 with one or more of the investor portfolio preferences may change as a function of time.

Based upon, at least in part, the comparison 102 of the one or more investor portfolio preferences having an associated 106 weighting factor, investor interest process 10 may generate 104 an interest score for the user relative to the security. The interest score for the user may be indicative of a probability of the user bidding on the security, and/or otherwise being interested in acquiring the security. Based upon the probability indicated by the interest score, trading application 20, a broker, or the like, may suggest the security to the user, e.g., as a possible security of interest to the user.

Continuing with the foregoing, security offerings may be matched to investors (e.g., the user) based upon the probability of investor interest in security offerings, e.g., which may be indicated by the interest score. As such, particularized offerings may be made to investors with a relatively high probability of interest in the offerings. In the context of restricted securities, the investors may be members of a network for trading restricted or unregistered securities (e.g., the Restricted Securities Trading Network managed by Restricted Stock Partners), e.g., giving rise to a pre-existing relationship between the network manager and the investors. Additionally, particular restricted securities offerings may be suggested to only those investors having a probable interest in the particular restricted securities offerings. Accordingly, a competitive bidding market for restricted securities may be established without utilizing general solicitation of buyers, i.e., without making an open general offering of the restricted securities. As such, transactions relating to the restricted securities may be compliant private transactions under the Securities Act of 1933.

A number of implementations have been described. Nevertheless, it will be understood that various modifications may be made. Accordingly, other implementations are within the scope of the following claims.

What is claimed is:

1. A method comprising:
defining one or more investor portfolio preferences for a user;
comparing the one or more investor portfolio preferences to one or more attributes of a security; and
generating an interest score for the user relative to the security.

2. The method of claim 1, wherein the one or more investor portfolio preferences for the user include one or more of: security type, security position size, security industry, security issuer market capitalization, and listed security ask price.

3. The method of claim 2, wherein defining the one or more investor portfolio preferences for the user includes defining one or more investor portfolio preferences based upon, at least in part, an investor survey.

4. The method of claim 1, wherein the one or more attributes of the security include one or more of: security type, security position size, security industry, security issuer market capitalization, and listed security ask price.

5. The method of claim 1, wherein the security includes a restricted security.

6. The method of claim 1, wherein comparing the one or more investor portfolio preferences to the one or more attributes of the security includes associating a weighting factor to one or more of the one or more investor portfolio preferences.

7. The method of claim 6, wherein the weighting factor is based upon, at least in part, one or more of: one or more stated investor portfolio preferences for the user, one or more historical transactions of the user, one or more historical bids of the user, one or more declared interests of the user, one or more listed positions monitored by the user, current portfolio holdings of the user, one or more user affirmed positions of interest, an indicated securities exchange preference of the user, and indicated special purchase interest of the user, a qualified institutional buyer status of the user, amount of assets under management by the user, and a relative time spent by the user viewing one or more securities positions.

8. The method of claim 1, wherein the interest score for the user is indicative a probability of the user bidding on the security.

9. A computer program product residing on a computer readable medium having a plurality of instructions stored thereon, which, when executed by a processor, cause the processor to perform operations comprising:
defining one or more investor portfolio preferences for a user;
comparing the one or more investor portfolio preferences to one or more attributes of a security; and
generating an interest score for the user relative to the security.

10. The computer program product of claim 9, wherein the one or more investor portfolio preferences for the user include one or more of: security type, security position size, security industry, security issuer market capitalization, and listed security ask price.

11. The computer program product of claim 10, wherein the instructions for defining the one or more investor portfolio preferences for the user include instructions for defining one or more investor portfolio preferences based upon, at least in part, an investor survey.

12. The computer program product of claim 9, wherein the one or more attributes of the security include one or more of: security type, security position size, security industry, security issuer market capitalization, and listed security ask price.

13. The computer program product of claim 9, wherein the security includes a restricted security.

14. The computer program product of claim 9, wherein the instructions for comparing the one or more investor portfolio preferences to the one or more attributes of the security include instructions for associating a weighting factor to one or more of the one or more investor portfolio preferences.

15. The computer program product of claim 14, wherein the weighting factor is based upon, at least in part, one or more of: one or more stated investor portfolio preferences for the user, one or more historical transactions of the user, one or more historical bids of the user, one or more declared interests of the user, one or more listed positions monitored by the user, current portfolio holdings of the user, one or more user affirmed positions of interest, an indicated securities exchange preference of the user, and indicated special purchase interest of the user, a qualified institutional buyer status of the user, amount of assets under management by the user, and a relative time spent by the user viewing one or more securities positions.

16. The computer program product of claim 9, wherein the interest score for the user is indicative a probability of the user bidding on the security.
